(19) United States
(12) Patent Application Publication
(10) Pub. No.: US 2018/0024282 A1
(43) Pub. Date: Jan. 25, 2018

(54) LIGHT CONTROL PLATE, DUAL-VIEW DISPLAY PANEL AND DISPLAY DEVICE

(71) Applicants: BOE TECHNOLOGY GROUP CO., LTD., Beijing (CN); HEFEI XINSHENG OPTOELECTRONICS TECHNOLOGY CO., LTD, Hefei (CN)

(72) Inventors: Yongcan WANG, Beijing (CN); Shuishui ZHANG, Beijing (CN); Quan GAN, Beijing (CN)

(21) Appl. No.: 15/656,285

(22) Filed: Jul. 21, 2017

(30) Foreign Application Priority Data
Jul. 21, 2016 (CN) 201610579002.X

(51) Int. Cl. G02B 5/04

(52) U.S. Cl. CPC G02B 5/045; G02F 2201/30; G02F 1/1335

(57) ABSTRACT

The invention relates to a light control plate, a dual-view display panel and a display device. The light control plate comprises: a substrate; a grating structure which is arranged above the substrate and has light-transmitting regions and light-blocking regions arranged alternately; and an optical device which is arranged on a boundary of adjacent light-transmitting region and light-blocking region and used for expanding a dual-view visual angle formed by the grating structure.

### FIELD OF THE INVENTION

The present invention belongs to the technical field of display, and particularly relates to a light control plate, a dual-view display panel and a display device.

### BACKGROUND OF THE INVENTION

Dual view is a technique which allows different display contents to be viewed in a left field of view and a right field of view of a same display screen. At present, the dual view is generally realized by a slit grating.

In the existing display products, to realize a larger visual angle, the thickness of a substrate of a display screen needs to be decreased. However, the decrease of the thickness of the substrate will increase the process difficulty, cause the screen to be easily damaged, and reduce the reliability.

### SUMMARY OF THE INVENTION

The present invention provides a light control plate, a dual-view display panel including the light control plate, and a display device, which realize a large dual-view visual angle without decreasing the thickness of a substrate of a display screen.

According to one aspect of the present invention, there is provided a light control plate, including: a substrate; a grating structure, which is arranged above the substrate and has light-transmitting regions and light-blocking regions arranged alternately; and, an optical device, which is arranged on a boundary of adjacent light-transmitting region and light-blocking region and used for expanding a dual-view visual angle formed by the grating structure.

According to an embodiment of the present invention, the optical device may be a triangular prism, which is arranged in the light-transmitting region and extends to at least partially cover the boundary of the light-transmitting region and the light-blocking region.

According to an embodiment of the present invention, the optical device is an isosceles triangular prism, and a center line of the vertex angle of the isosceles triangular prism coincides with a center line of the light-transmitting region in a column direction.

According to an embodiment of the present invention, a plurality of isosceles triangular prisms may be arranged in the form of an array.

According to an embodiment of the present invention, the refractivity of the optical device may be larger than that of the substrate.

According to an embodiment of the present invention, the optical device may be formed from a resin material.

According to another aspect of the present invention, there is provided a dual-view display panel, including a display screen having a plurality of pixel regions, and a light control plate arranged on a display side of the display screen. The light control plate includes the light control plate according to the present invention, and the optical device of the light control plate corresponds to two adjacent pixel regions of the display screen.

According to an embodiment of the present invention, a black matrix may be arranged between two adjacent pixel regions of the display screen, and a center line of the light-transmitting region of the grating structure of the light control plate in a column direction coincides with a center line of the black matrix in the column direction.

According to an embodiment of the present invention, the width of the optical device of the light control plate in a row direction may be smaller than the width of one of the two pixel regions corresponding to the optical device in the row direction.

According to an embodiment of the present invention, the display screen may be a liquid crystal display screen or an organic light emission display screen.

According to another aspect of the present invention, there is provided a display device, including the dual-view display panel according to the present invention.

In the light control plate, the dual-view display panel and the display device according to the present invention, a larger dual-view visual angle may be realized without decreasing the thickness of a substrate of a display screen.

### BRIEF DESCRIPTION OF THE DRAWINGS

FIG. 1 is a schematic structure diagram of a dual-view display panel in the prior art;

FIGS. 2A and 2B are principle diagrams for describing the calculation of a dual-view visual angle in the prior art;

FIG. 3 is a schematic structure diagram of a light control plate according to an embodiment of the present invention;

FIGS. 4A and 4B are principle diagrams for describing the calculation of a dual-view visual angle of the light control plate according to an embodiment of the present invention;

FIG. 5 is a schematic structure diagram of a dual-view display panel including a light control plate according to an embodiment of the present invention; and

FIG. 6 is a principle diagram schematically showing the formation of dual view by a dual-view display panel.

### DETAILED DESCRIPTION OF THE PREFERRED EMBODIMENTS

To make those skilled in the art better understand the technical solutions of the present invention, a light control plate, a dual-view display panel and a display device of the present invention will be further described below in detail in conjunction with specific implementations and the accompanying drawings.

FIG. 6 is a principle diagram schematically showing the formation of dual view by a dual-view display panel.

As shown in FIG. 6, the dual-view display panel may form left and right fields of view in which different display images are respectively viewed, and a crosstalk region in which two different images are viewed simultaneously will be formed between the left field of view and the right field of view. The formed left field of view and right field of view each have a particular visual angle, i.e., a dual-view visual angle.

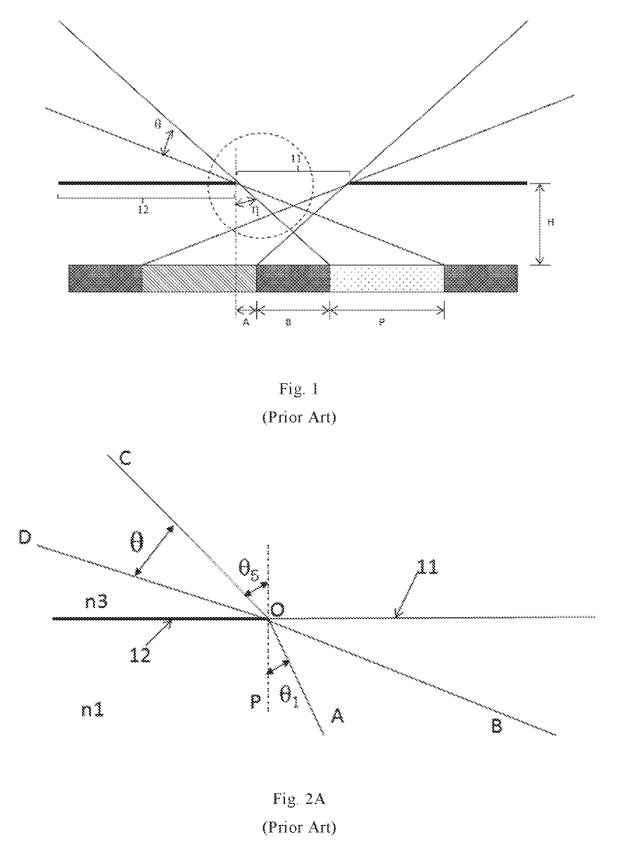

FIG. 1 is a schematic structure diagram of a dual-view display panel in the prior art.

FIG. 1 shows a simplified dual-view model. A slit grating having light-transmitting stripes 11 and light-blocking stripes 12 arranged periodically is disposed above a display screen, so that the dual view is realized. Key factors influencing the dual-view visual angle include a vertical distance from the slit grating to a pixel point.

As shown in FIG. 1, the width of one pixel point (for example, a sub-pixel constituting a pixel) is P; the width of a black matrix between two adjacent pixel points is B; the vertical distance from the slit grating to a pixel point is H; a center line of the light-transmitting stripe 11 of the slit grating in a column direction of the display panel coincides with a center line of the black matrix between two adjacent pixel points; and the horizontal distance from an edge of the light-transmitting stripe 11 to an edge of the corresponding black matrix is A. Accordingly, the horizontal width (i.e., the width in a row direction of the display panel) of the light-transmitting stripe 11 is B+2A.

Referring to FIG. 1, θ is a visual angle (i.e., a dual-view visual angle) of a single field of view (e.g., the field of view on the left of FIG. 1). Within the range of the angle θ, a viewer can only view the light emitted by the pixel point on the right of FIG. 1, but cannot view the light emitted by the pixel point on the left of FIG. 1. The visual angle θ is calculated as follows.

### From

$$tan ( θ + η ) = \frac{( tan θ + tan η )}{( 1 - tan θtan η )} = \frac{P + B + A}{H} , \\ where$$

$$tan η = \frac{B + A}{H} ,$$

it can be obtained that

$$\frac{tan θ + \frac{B + A}{H}}{1 - tan θ ( \frac{B + A}{H} )} = \frac{P + B + A}{H} .$$

Hence, the following calculation formula of the visual angle θ is obtained:

$$tan θ = \frac{HP}{{H}^{2} + ( B + A ) ( B + A + P )} .$$

It is assumed that the width P of each of the pixel points is equal to 80 μm, the width B of the black matrix is equal to 10 μm, and the horizontal distance A from an edge of the light-transmitting stripe 11 to an edge of the corresponding black matrix is equal to 5 μm. If the desired visual angle θ is equal to 45°, the following equation may be obtained from the above calculation formula of the visual angle θ:

$$tan {45}^{∘} = \frac{H \times 80}{{H}^{2} + ( 10 + 5 ) ( 10 + 5 + 80 )} .$$

Then, the following is obtained by solving the above equation: H≈53 μm or 27 μm. In other words, to ensure a certain dual-view visual angle θ (e.g., θ=45°), the vertical distance H from the slit grating to the pixel point needs to be set as 53 μm (or even less). In the display panel, the distance H is essentially, for example, the thickness of a color filter substrate of a liquid crystal display (LED) screen. If the thickness is designed as 53 μm (or even less), the process will be highly difficult. Additionally, such a thin substrate is very likely to result in the breakage of the screen, and thus the reliability is very low.

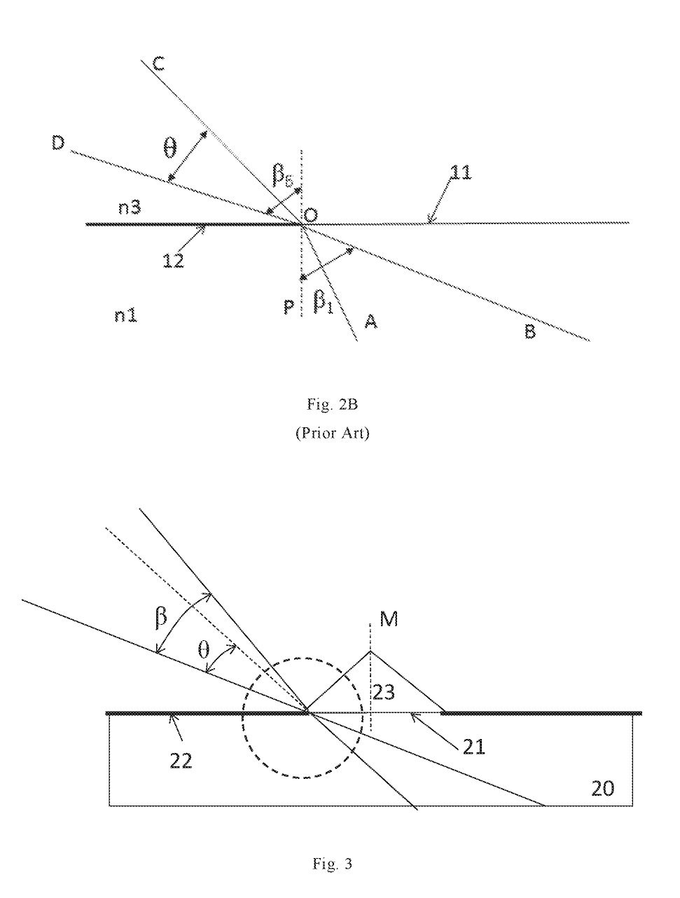

FIGS. 2A and 2B are principle diagrams for describing the calculation of the dual-view visual angle θ in the prior art, and show enlarged views of the circular region in FIG. 1.

Referring to FIGS. 2A and 2B, the point O denotes a boundary between a light-transmitting stripe 11 and a light-blocking stripe 12, and the line P denotes a normal perpendicular to the surface of the substrate at the point O. The line A denotes the light emitted by a left edge of a pixel point on the right of FIG. 1, and the line C denotes refracted light of the light A. The line B denotes light emitted by a right edge of a pixel point on the right of FIG. 1, and the line D denotes refracted light of the light B. The refractivity of the substrate (e.g., glass) is n1, and the refractivity of air is n3. θ₁ is an angle of incidence of the light A, and θ₅ is an angle of refraction of the refracted light C. β₁ is an angle of incidence of the light B, and β₅ is an angle of refraction of the refracted light D.

In accordance with the refraction principle, the followings are obtained:

n1×sin θ₁=n3×sin θ₅,

n1×sin β₁=n3×sin β₅.

Since n1>n3, then θ₅>θ₁ and β₅>β₁, and the visual angle θ is equal to β₅−β₅.

FIG. 3 is a schematic structure diagram of a light control plate according to an embodiment of the present invention.

Referring to FIG. 3, the light control plate according to this embodiment of the present invention includes a substrate 20, a grating structure arranged on the substrate 20, and an optical device 23 arranged on the grating structure. The grating structure includes light-transmitting regions 21 and light-blocking regions 22 arranged alternately, and the optical device 23 is arranged on a boundary of adjacent light-transmitting region 21 and light-blocking region 22 and used for expanding a dual-view visual angle formed by the grating structure, i.e., expanding the dual-view visual angle θ shown in FIG. 1 into a dual-view visual angle β.

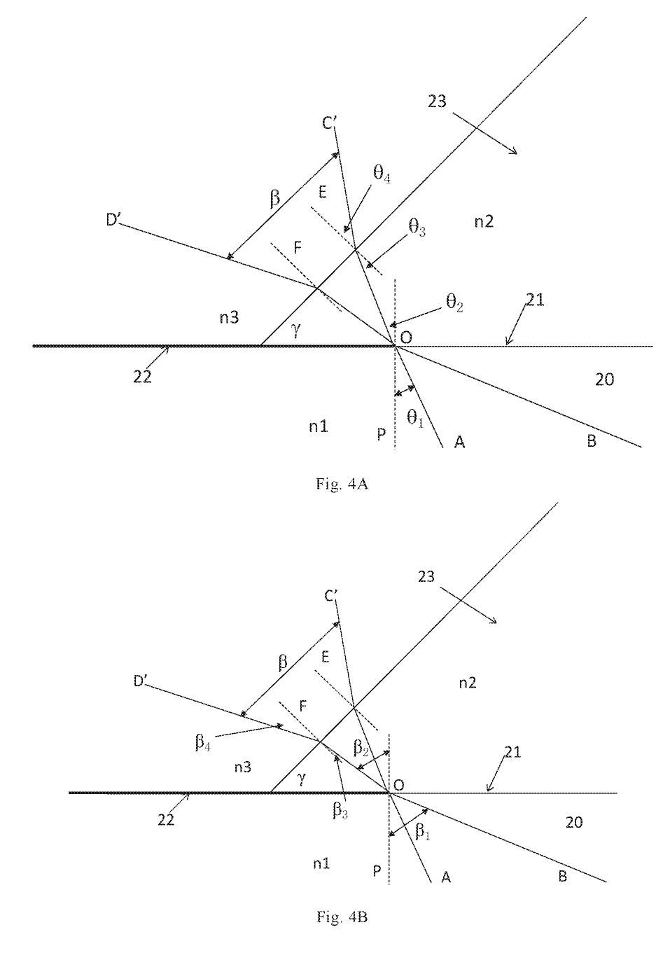

According to an embodiment of the present invention, the optical device 23 may be a triangular prism, which is arranged in the light-transmitting region 21 and extends to at least partially cover the boundary of the light-transmitting region 21 and the light-blocking region 22. This will be described below in more detail with reference to FIGS. 4A and 4B.

According to an embodiment of the present invention, the optical device 23 may be an isosceles triangular prism 23, and a center line M of the vertex angle of the isosceles triangular prism coincides with a center line of the light-transmitting region 21 in a column direction. For the light from a light-transmitting region 21 and the light at boundaries of the light-transmitting region 21 and two light-blocking regions 22 adjacent to the light-transmitting region 21, the optical device 23 may expand the dual-view visual angle thereof, although the situation at only one boundary is shown in FIG. 3.

As a whole, a plurality of optical devices 23 may be circularly arranged in the form of an array, to be formed on each light-transmitting region 21 of each grating structure. According to different positions where the optical devices 23 are formed (for example, the optical devices 23 are formed within a center region of the light control plate or within an edge region of the light control plate), the optical devices 23 formed as isosceles triangular prisms may have different vertex angles, so that the apexes of a plurality of isosceles triangular prisms 23 are located at different heights relative to the surface of the substrate 20.

According to an embodiment of the present invention, the refractivity of the optical device 23 may be larger than that of the substrate 20. This will be described below in more detail with reference to FIGS. 4A and 4B.

FIGS. 4A and 4B are principle diagrams for describing the calculation of a dual-view visual angle of the light control plate according to this embodiment of the present invention. Reference signs identical or similar to the reference signs in FIG. 2 represent identical elements or features, which will not be described in detail here.

Referring to FIGS. 4A and 4B, the point O denotes a boundary of a light-transmitting stripe 21 and a light-blocking stripe 22, the dashed line P denotes a normal perpendicular to the surface of the substrate 20 at the point O, and the dashed lines E and F denote normals perpendicular to an interface between the optical device 23 and the air. The line C′ denotes refracted light of the light A, and the line D′ denotes refracted light of the light B. The refractivity of the substrate 20 (e.g., a glass substrate) is n1, and the refractivity of air is n3. The optical device 23 is formed as an isosceles triangular prism, which is arranged in the light-transmitting region 21 and extends to at least partially cover the boundary of the light-transmitting region 21 and the light-blocking region 22.

As shown in FIG. 4A, θ₁ is an angle of incidence of the light A, θ₂ is an angle of refraction of the light A in the optical device 23, θ₃ is an angle of incidence of the light on the surface of the optical device 23, and θ₄ is an angle of refraction of the light on the surface of the optical device 23. Similarly, as shown in FIG. 4B, β₁ is an angle of incidence of the light B, β₂ is an angle of refraction of the light B in the optical device 23, β₃ is an angle of incidence of the light on the surface of the optical device 23, and β₄ is an angle of refraction of the light on the surface of the optical device 23.

The refractivity of the optical device 23 is n2, the refractivity of the substrate 20 is n1, and the refractivity of the air is n3, wherein n2>n1 and n2>n3.

In accordance with the refraction principle, the followings are obtained:

n1×sin θ₁=n2×sin θ₂,

n1×sin β₁=n2×sin β₂.

Since n2>n1, then θ₁>θ₂ and β₁>β₂.

Further, in accordance with the refraction principle, the followings are obtained:

n2×sin θ₃=n3×sin θ₄,

n2×sin β₃=n3×sin β₄.

Since n2>n3, then θ₄>θ₃ and β₄>β₃.

The visual angle β of the light control plate according to this embodiment of the present invention is equal to θ₄+β₄, and thus the visual angle is increased. In other words, a scope, within which the fields of view provided by the light control plate can be viewed, is extended.

According to an embodiment of the present invention, the optical device 23 may be formed from a resin material, so that the cost may be controlled. During the preparation process, the light-blocking regions 22 and the optical device 23 may be formed above the substrate 20 by using a same halftone mask plate or gray-tone mask plate through one patterning process.

According to an embodiment of the present invention, a dual-view display panel including the light control panel according to the present invention is provided.

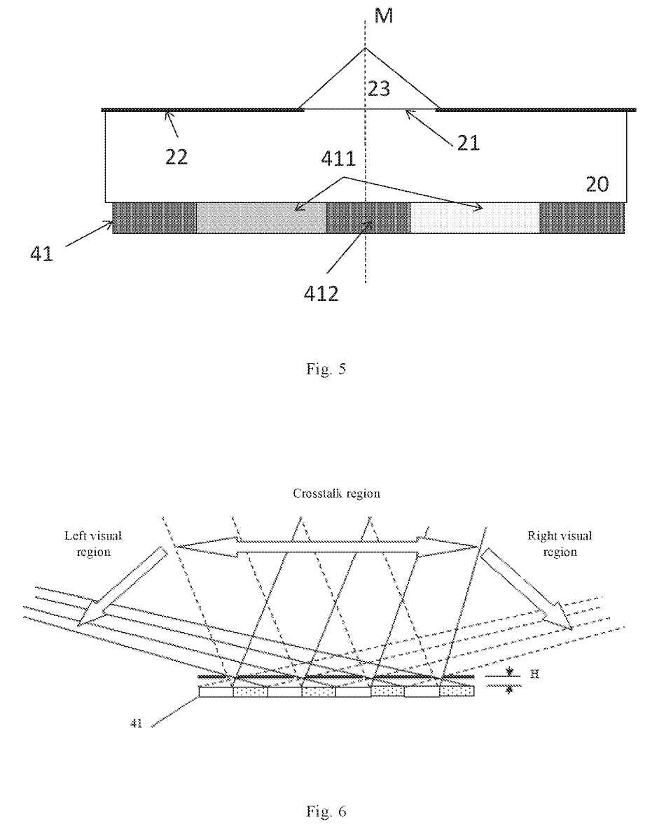

FIG. 5 is a schematic structure diagram of the dual-view display panel including a light control plate according to the embodiment of the present invention.

Referring to FIG. 5, the light control plate according to the present invention shown in FIG. 3 may be arranged on a light outgoing side of a display screen 41. The display screen 41 includes a plurality of pixel regions 411. Each optical device 23 of the light control plate corresponds to two adjacent pixel regions 411. A center line M of the optical device 23 (i.e., a center line of the light-transmitting region 21 in a column direction) is aligned with a center line of the black matrix 412 between two adjacent pixel regions 411.

Referring to FIGS. 3, 4A, 4B and 5, a half of the size of the vertex angle of the optical device 23 is between the angle θ₂ of refraction of the light (the light A shown in FIG. 4A) emitted by an edge, close to the center line M, of a pixel region 411 corresponding to this optical device 23 and the angle β₂ of refraction of the light (the light B shown in FIG. 4A) emitted by an edge, away from the center line M, of this pixel region 411, in order to ensure the way of refracting light shown in FIGS. 4A and 4B. That is, the refracted lights C′ and D′ are refracted to two opposite sides of the normals E and F, respectively.

According to an embodiment of the present invention, the base angle of the optical device 23 formed as an isosceles triangular prism is γ. As shown in FIG. 4A, γ=θ₂+θ₃; the angle of refraction of the light A is θ₂; the vertex angle of the optical device 23 is 180°−2γ, and, a half of the size of the vertex angle is 90−θ₂−θ₃>θ₂. In addition, as shown in FIG. 4B, γ=β₂−β₃; the angle of refraction of the light B is β₂, and a half of the size of the vertex angle of the optical device 23 is 90°−γ=90°−β₂+β₃<β₂.

According to an embodiment of the present invention, the width of the optical device 23 in a row direction is smaller than the width of the pixel region 411, so that a larger visual range is ensued.

Since the optical device 23 formed as the isosceles triangular prism will not result in chromatic dispersion, and light of pure color generated by the pixel regions 411 may have a maximum color gamut and a best display effect. According to an embodiment of the present invention, each optical device 23 may be of a same size in order to simplify the preparation process.

According to an embodiment of the present invention, the display screen 41 may be a liquid crystal display (LCD) screen, including a color filter substrate and an array substrate which are arranged oppositely, and a liquid crystal layer located between the color filter substrate and the array substrate. The substrate 20 of the light control plate according to the present invention may be a color filter substrate of the LCD screen.

Alternatively, the display screen 41 may be an organic light emission display (OLED) screen, and the substrate 20 of the light control plate according to the present invention may be a substrate of the OLED screen on a display side.

The dual-view display panel according to the present invention may be applied to various display devices, including, but not limited to, an LCD panel, electronic paper, an OLED panel, a mobile phone, a tablet computer, a TV set, a display, a notebook computer, a digital photo frame, a navigator or any other products or components with a display function.

Although various embodiments of the present invention have been described above in detail with reference to the accompanying drawings, these implementations are merely exemplary implementations used for describing the principle of the present invention, and the present invention is not limited thereto. One of ordinary skill in the art may make various modifications and improvements without departing from the spirit and essence of the present invention, and those modifications and improvements shall fall into the protection scope of the present invention.

1. A light control plate, comprising:
a substrate;
a grating structure, which is arranged above the substrate and has light-transmitting regions and light-blocking regions arranged alternately; and
an optical device, which is arranged on a boundary of adjacent light-transmitting region and light-blocking region and used for expanding a dual-view visual angle formed by the grating structure.

2. The light control plate according to claim 1, wherein the optical device is a triangular prism, which is arranged in the light-transmitting region and extends to at least partially cover the boundary of the light-transmitting region and the light-blocking region.

3. The light control plate according to claim 2, wherein the optical device is an isosceles triangular prism, and a center line of a vertex angle of the isosceles triangular prism coincides with a center line of the light-transmitting region in a column direction.

4. The light control plate according to claim 3, wherein a plurality of isosceles triangular prisms are arranged in the form of an array.

5. The light control plate according to claim 1, wherein a refractivity of the optical device is larger than that of the substrate.

6. The light control plate according to claim 1, wherein the optical device is formed from a resin material.

7. A dual-view display panel, comprising a display screen having a plurality of pixel regions, and a light control plate arranged on a display side of the display screen,
wherein the light control plate comprises the light control plate according to claim 1, and
the optical device of the light control plate corresponds to two adjacent pixel regions of the display screen.

8. The dual-view display panel according to claim 7, wherein a black matrix is arranged between two adjacent pixel regions of the display screen, and a center line of the light-transmitting region of the grating structure of the light control plate in a column direction coincides with a center line of the black matrix in the column direction.

9. The dual-view display panel according to claim 8, wherein a width of the optical device of the light control plate in a row direction is smaller than a width of one of the two pixel regions corresponding to the optical device in the row direction.

10. The dual-view display panel according to claim 7, wherein the display screen is a liquid crystal display screen or an organic light emission display screen.

11. A display device, comprising the dual-view display panel according to claim 7.

12. The display device according to claim 11, wherein a black matrix is arranged between two adjacent pixel regions of the display screen of the dual-view display panel, and a center line of the light-transmitting region of the grating structure of the light control plate in a column direction coincides with a center line of the black matrix in the column direction.

13. The display device according to claim 12, wherein a width of the optical device of the light control plate of the dual-view display panel in a row direction is smaller than a width of one of the two pixel regions corresponding to the optical device in the row direction.

14. The display device according to claim 11, wherein the display screen of the dual-view display panel is a liquid crystal display screen or an organic light emission display screen.
